(19) United States
(12) Patent Application Publication
(10) Pub. No.: US 2020/0100093 A1
(43) Pub. Date: Mar. 26, 2020

(54) DETECTING OR SENDING DISCOVERY SIGNAL, ASSOCIATED BASE STATION, AND ASSOCIATED USER EQUIPMENT

(71) Applicant: HUAWEI TECHNOLOGIES CO., LTD., Shenzhen (CN)

(72) Inventors: Zhanyang REN, Madrid (ES); Wurong ZHANG, Beijing (CN); Zhenyu LI, Beijing (CN); Jinxia HAN, Beijing (CN)

(21) Appl. No.: 16/697,875

(22) Filed: Nov. 27, 2019

Related U.S. Application Data
(63) Continuation of application No. PCT/CN2017/086717, filed on May 31, 2017.

(51) Int. Cl. H04W 8/00; H04W 16/14; H04W 74/08

(52) U.S. Cl. CPC H04W 8/005; H04W 74/0808; H04W 16/14

(57) ABSTRACT

Embodiments of this application provide methods for detecting or sending a discovery signal, associated base station, and associated user equipment. A method includes: performing, by a base station, first carrier sense on first R subframes of one radio frame in a time sequence in a first discovery signal measurement timing (DMTC) window; and if the first carrier sense succeeds, sending, by the base station, a discovery signal in M consecutive subframes, where M is greater than or equal to 2, and the first subframe of the M consecutive subframes is located in the radio frame in the first DMTC window. The embodiments of this application are used to support enhanced discovery signal transmission by using a new DMTC, so that to implement accessing UE in a weak coverage scenario, thereby ensuring cell coverage performance.

### CROSS-REFERENCE TO RELATED APPLICATIONS

This application is a continuation of International Application No. PCT/CN2017/086717, filed on May 31, 2017, the disclosure of which is hereby incorporated by reference in its entirety.

### TECHNICAL FIELD

This application relates to the communications field, and in particular, to a method for sending a discovery signal, a method for detecting a discovery signal, an associated base station, and associated user equipment.

### BACKGROUND

In an MF (MulteFire) system, user equipment (UE) implements a network access procedure by receiving a discovery signal (DRS) of a base station device. Usually, a base station can send a discovery signal to a plurality of UEs only by using one subframe. The signal includes a primary synchronization signal (PSS), an MF-primary synchronization signal (MF-PSS), a secondary synchronization signal (SSS), an MF-secondary synchronization signal (MF-SSS), and an MF-physical broadcast channel (MF-PBCH). The UE receives the DRS and parses the PSS, the MF-PSS, the SSS, and the MF-SSS, to obtain a physical cell identifier (physical cell ID, PCI), parses the MF-PBCH to obtain information such as system bandwidth, and implements synchronization with a clock and a frequency of a base station. The DRS is transmitted in the subframe and occupies 12 or 14 orthogonal frequency division multiplexing (OFDM) symbols, where the PSS, the SSS, the MF-PSS, and the MF-SSS each occupy one symbol. In addition, the MF-PBCH occupies six orthogonal frequency division multiplexing (OFDM) symbols.

When the MF system is deployed in a scenario such as a port, a wharf, and an automated production flow, because the user equipment usually has relatively high mobility, during movement of the user equipment, a radio signal sent by the base station is easily blocked by various objects between the user equipment and the base station. Consequently, radio signal quality is relatively poor, and the user equipment cannot normally receive the radio signal. On the other hand, because of a relatively large quantity of user equipment, during the movement, radio signals might be blocked by each other, and consequently, the user equipment cannot normally receive data sent by the base station. In this case, there is a heightened requirement for quality of a signal delivered by the base station, and the base station needs to provide a better radio coverage capability to respond to a scenario of relatively poor radio signal quality.

In an existing MF system, a DRS is transmitted in one subframe. When UE is in a weak coverage scenario with relatively poor signal quality, the DRS cannot be normally received. Therefore, the UE cannot obtain a synchronization signal and MF-PBCH information, so that the UE cannot synchronize with the clock and the frequency of the base station, and the UE cannot obtain system information, so that the UE cannot access a core network by using the base station.

### SUMMARY

Embodiments of this application provide a method for sending a discovery signal, a method for detecting a discovery signal, a base station, and user equipment, so that enhanced discovery signal transmission is supported by using a new discovery signal measurement timing configuration, to implement accessing UE in a weak coverage scenario, thereby improving cell coverage performance.

According to one aspect, a method for sending one or more discovery signals is provided. The method includes: performing, by a base station, first carrier sense on first R subframes of one radio frame in a time sequence in a first discovery signal measurement timing (DMTC) window; and if the first carrier sense succeeds, sending, by the base station, the discovery signal in M consecutive subframes, where M is greater than or equal to 2; the first subframe of the M consecutive subframes is located in the radio frame in the first DMTC window; and the first DMTC window includes N subframes, and both M and R are natural numbers. That the first carrier sense succeeds may be successfully performing the first carrier sense before the first subframe, and it is determined that a channel is idle. In other words, in this embodiment of this application, the radio frame in the first DMTC window may be divided into two parts. The first carrier sense may start to attempt to be performed before the first subframe, namely, a subframe 0. If the first carrier sense succeeds in a range of the first R subframes, the discovery signal may be sent in a plurality of consecutive subframes. Compared with the conventional approaches in which a discovery signal DRS occupies one subframe, in this embodiment of this application, enhanced discovery signal transmission can be supported by using a new discovery signal measurement timing configuration, to implement accessing UE in a weak coverage scenario, thereby improving cell coverage performance.

In a possible implementation, the first DMTC window includes the N subframes; and if N is less than or equal to 11-M, R is less than or equal to N; or if N is greater than 11-M, R is less than or equal to 11-M. In other words, in the radio frame in the DMTC window, at most 11-M subframes may be used to perform the first carrier sense, and the discovery signal occupies M subframes, so that the M consecutive subframes may be in the radio frame, and do not conflict with a format of a discovery signal specified at a location of a subframe 0 outside an existing DMTC window.

In a possible implementation, discovery signals carried in subframes of the M consecutive subframes may be the same or different. For example, a plurality of DRSs, namely, enhanced DRSs may be sent or a newly defined enhanced discovery signal (eDRS) may be sent in the M consecutive subframes. A core difference between the eDRS and the DRS is that a quantity of subframes occupied when the eDRS is sent is different from a quantity of subframes occupied when the DRS is sent. The DRS occupies one subframe, while the eDRS may occupy a plurality of subframes.

In a possible implementation, the first DMTC window includes the N subframes, and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q. In other words, at most 11-Q subframes in the radio frame in the first DMTC window may be used to perform the first carrier sense. Because the first Q subframes in the M consecutive subframes carry the subframe numbers, UE may determine, based on the subframe numbers of the first Q subframes, the format of the discovery signal sent by the base station in the M consecutive subframes.

In a possible implementation, before the base station sends the discovery signal, the base station determines the format of the discovery signal in the M consecutive subframes based on the subframe numbers of the first Q subframes.

In a possible implementation, if the first carrier sense fails, the base station performs second carrier sense on a subframe, other than the first R subframes, of one radio frame in the time sequence in the first DMTC window, or the base station performs second carrier sense on a subframe, other than the first R subframes, in the first DMTC window. In other words, if the first carrier sense fails in the first R subframes, the second carrier sense may be performed before a first subframe, other than the R subframes, in one radio frame. For example, the first carrier sense is sending the above described eDRS for configuration. If the first carrier sense fails in the first R subframes, there is no eDRS sending opportunity. The second carrier sense configured for the DRS is performed on a subframe, other than the R subframes, in the radio frame, so that a DRS sending opportunity can be obtained. A period of time for which an idle channel is needed for the first carrier sense to succeed is not shorter than a period of time for which an idle channel is needed for the second carrier sense to succeed. The first carrier sense may be applicable to sending of the eDRS occupying more than one subframe, and the second carrier sense may be applicable to sending of the DRS occupying no more than one subframe.

In a possible implementation, the first DMTC window includes the N subframes; and if N is less than or equal to 11-Q, a start subframe in the M consecutive subframes is in the N subframes; or if N is greater than 11-Q, a start subframe in the M consecutive subframes is in first 11-Q subframes in the radio frame, where the first Q subframes in the M consecutive subframes carry subframe numbers. In other words, the at most 11-Q subframes may be used to perform the first carrier sense.

In a possible implementation, the first DMTC window includes one or more radio frames, or a part of one radio frame.

According to another aspect, a method for detecting one or more discovery signals is provided. User equipment UE detects a discovery signal in first R subframes of one radio frame in a first discovery signal measurement timing (DMTC) window, where the discovery signal is carried in M consecutive subframes, and M is greater than or equal to 2; and the first subframe of the M consecutive subframes is located in the radio frame in the first DMTC window, and both M and R are natural numbers. In other words, for the UE, the UE considers that a base station starts to send the discovery signal from the first R subframes of the radio frame in the first DMTC window, and the UE only needs to detect, in the first R subframes, whether to start to receive the discovery signal.

In a possible implementation, the first DMTC window includes N subframes; and if N is less than or equal to 11-M, R is less than or equal to N; or if N is greater than 11-M, R is less than or equal to 11-M. In other words, a range of the first R subframes is determined based on a quantity of subframes occupied by the first DMTC window and a quantity of subframes carrying the discovery signal, so that subframes occupied when the discovery signal is sent are in one radio frame, and do not conflict with a format of a discovery signal specified at a location of a subframe 0 outside an existing DMTC window.

In a possible implementation, the first DMTC window includes the N subframes; and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q. The UE determines formats of the M consecutive subframes based on the subframe numbers of the first Q subframes. In other words, even if the M consecutive subframes belong to a plurality of radio frames, the UE may determine the formats of the M consecutive subframes based on the subframe numbers of the first Q subframes.

According to still another aspect, a base station is provided. The base station includes a receiving module, a sending module, and a processing module, where the receiving module is configured to perform first carrier sense on first R subframes of one radio frame in a time sequence in a first discovery signal measurement timing (DMTC) window; the processing module is configured to determine whether the first carrier sense succeeds; and if the first carrier sense succeeds, the sending module is configured to send a discovery signal in M consecutive subframes, where M is greater than or equal to 2, and the first subframe of the M consecutive subframes is located in the radio frame in the first DMTC window, and both M and R are natural numbers.

In a possible implementation, the first DMTC window includes N subframes, and if N is less than or equal to 11-M, R is less than or equal to N; or if N is greater than 11-M, R is less than or equal to 11-M.

In a possible implementation, discovery signals carried in subframes of the M consecutive subframes may be the same or different.

In a possible implementation, the first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, before the sending module is configured to send the discovery signal, the processing module is configured to determine a format of the discovery signal in the M consecutive subframes based on the subframe numbers carried by the first Q subframes.

In a possible implementation, if the first carrier sense fails, the receiving module is configured to perform second carrier sense on a subframe, other than the first R subframes, of one radio frame in the time sequence in the first DMTC window, or perform second carrier sense on a subframe, other than the first R subframes, in the first DMTC window.

In a possible implementation, if the second carrier sense succeeds, the sending module sends a discovery signal in one subframe in the first DMTC window.

In a possible implementation, the first DMTC window includes the N subframes, and if N is less than or equal to 11-Q, a start subframe in the M consecutive subframes is in the N subframes; or if N is greater than 11-Q, a start subframe in the M consecutive subframes is in first 11-Q subframes in the radio frame in the first DMTC window, where the first Q subframes in the M consecutive subframes carry the subframe numbers.

In a possible implementation, the first DMTC window includes one or more radio frames, or a part of one radio frame.

According to still another aspect, user equipment (UE) is provided. The UE includes a receiving module, where the receiving module is configured to detect a discovery signal in first R subframes of one radio frame in a first discovery signal measurement timing (DMTC) window, where the discovery signal is carried in M consecutive subframes, and M is greater than or equal to 2; and the first subframe of the M consecutive subframes is located in the radio frame in the first DMTC window, and both M and R are natural numbers.

In a possible implementation, the first DMTC window includes N subframes, where if N is less than or equal to 11-M, R is less than or equal to N; or if N is greater than 11-M, R is less than or equal to 11-M. The receiving module is further configured to receive the discovery signal. The UE further includes a processing module, where the processing module is configured to determine formats of the M consecutive subframes based on subframe numbers of first Q subframes.

In a possible implementation, the first DMTC window includes the N subframes; and the first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, the UE determines the formats of the M consecutive subframes based on the subframe numbers of the first Q subframes.

According to yet another aspect, a base station is provided. The base station includes a receiver, a transmitter, and a processor, where the receiver is configured to perform first carrier sense on first R subframes of one radio frame in a time sequence in a first discovery signal measurement timing (DMTC) window; and if the first carrier sense succeeds, the transmitter is configured to send a discovery signal in M consecutive subframes, where M is greater than or equal to 2; and the first subframe of the M consecutive subframes is located in the radio frame in the first DMTC window, and both M and R are natural numbers.

In a possible implementation, the first DMTC window includes N subframes, where if N is less than or equal to 11-M, R is less than or equal to N; or if N is greater than 11-M, R is less than or equal to 11-M.

In a possible implementation, the discovery signal comprises multiple discovery signals, two or more of the multiple discovery signals carried in subframes of the M consecutive subframes may be the same or different.

In a possible implementation, the first DMTC window includes the N subframes; and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, before the transmitter is configured to send the discovery signal, the processor is configured to determine a format of the discovery signal in the M consecutive subframes based on the subframe numbers carried by the first Q subframes.

In a possible implementation, if the first carrier sense fails, the receiver is configured to perform second carrier sense on a subframe, other than the first R subframes, of one radio frame in the time sequence in the first DMTC window, or the receiver is configured to perform second carrier sense on a subframe, other than the first R subframes, in the first DMTC window.

In a possible implementation, if the second carrier sense succeeds, the transmitter is configured to send a discovery signal in one subframe in the first DMTC window.

In a possible implementation, the first DMTC window includes the N subframes; and if N is less than or equal to 11-Q, a start subframe in the M consecutive subframes is in the N subframes; or if N is greater than 11-Q, a start subframe in the M consecutive subframes is in first 11-Q subframes in the radio frame, where the first Q subframes in the M consecutive subframes carry the subframe numbers.

In a possible implementation, the first DMTC window includes one or more radio frames, or a part of one radio frame.

According to still another aspect, user equipment (UE) is provided. The UE includes a receiver and a transmitter, where the receiver is configured to detect a discovery signal in first R subframes of one radio frame in a first discovery signal measurement timing (DMTC) window, where the discovery signal is carried in M consecutive subframes, and M is greater than or equal to 2; the first subframe of the M consecutive subframes is located in the radio frame in the first DMTC window, and both M and R are natural numbers.

In a possible implementation, the first DMTC window includes N subframes; and if N is less than or equal to 11-M, R is less than or equal to N; or if N is greater than 11-M, R is less than or equal to 11-M.

In a possible implementation, the first DMTC window includes the N subframes; and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, the receiver is configured to receive the discovery signal. The UE further includes a processor, where before the transmitter is configured to send the discovery signal, the processor is configured to determine a format of the discovery signal in the M consecutive subframes based on subframe numbers of first Q subframes.

According to still another aspect, an embodiment of this application provides a computer storage medium, where when the program is executed by a processor, it enables the processor to perform the method in any possible design of the above described base station and/or user equipment.

According to still another aspect, an embodiment of this application provides a computer program product, where when the computer program product is run on a computer, it enables the computer to perform the method in any possible design of the above described base station and/or user equipment.

The embodiments of this application provide a method for sending a discovery signal, a method for detecting a discovery signal, a base station, and user equipment. The base station performs first carrier sense on first R subframes of one radio frame in a time sequence in a first discovery signal measurement timing (DMTC) window; and if the first carrier sense succeeds, the base station sends a discovery signal in M consecutive subframes, where M is greater than or equal to 2, and the first subframe of the M consecutive subframes is located in the radio frame in the first DMTC window; and both M and R are natural numbers. In other words, in the embodiments of this application, the radio frame in the first DMTC window may be divided into two parts. The first carrier sense may start to attempt to be performed before the first subframe, namely, a subframe 0. If the first carrier sense succeeds in a range of the first R subframes, the discovery signal may be sent in a plurality of consecutive subframes. Compared with the conventional approaches in which a discovery signal (DRS) occupies one subframe, in embodiments of this application, enhanced discovery signal transmission is supported by using a new discovery signal measurement timing configuration, to implement accessing UE in a weak coverage scenario, thereby improving cell coverage performance.

### BRIEF DESCRIPTION OF DRAWINGS

The following detailed description of exemplary non-limiting illustrative embodiments is to be read in conjunction with the drawings of which:

FIG. 1 is a schematic diagram of a scenario in which an MF base station deployed based on an unlicensed band and wireless fidelity (Wi-Fi) coexist according to an embodiment of this application;

FIG. 2 is a schematic diagram of signal fading resulting from blocking according to an embodiment of this application;

FIG. 3 is a schematic diagram of a configuration parameter of a DMTC window in which a DRS is sent according to an embodiment of this application;

FIG. 4 is a schematic diagram of a format of an eDRS according to an embodiment of this application;

FIG. 5 is a schematic diagram of a format of an eDRS according to an embodiment of this application;

FIG. 6 is a schematic diagram of subframes occupied when an eDRS is sent in a DMTC window according to an embodiment of this application;

FIG. 7 is a schematic diagram of a subframe in which sending of an eDRS exceeds a DMTC window according to an embodiment of this application;

FIG. 8A is a schematic flowchart of a DMTC configuration method according to an embodiment of this application;

FIG. 8B is a schematic diagram of three possible formats of an eDRS according to an embodiment of this application;

FIG. 9 is a schematic diagram of an attempt to perform Cat.4 LBT and an attempt to perform Cat.2 LBT in a DMTC window according to an embodiment of this application;

FIG. 10 is a schematic diagram of an attempt to perform Cat.4 LBT and an attempt to perform Cat.2 LBT when a DMTC window is added according to an embodiment of this application;

FIG. 11 is a schematic structural diagram of a base station according to an embodiment of this application; and

FIG. 12 is a schematic structural diagram of a base station according to an embodiment of this application.

### DESCRIPTION OF EMBODIMENTS

For ease of understanding, example descriptions of some concepts related to embodiments of this application are provided for reference, as shown below:

Listen-before-talk (LBT) is a sense-before-transmit manner, indicating that each network element needs to perform the LBT before sending data. To be specific, the network element can send the data only after detecting that a channel is idle, and can at most send data within a finite duration after preempting the channel each time.

In an MF system, before sending data, a base station can sense a signal by using two categories of the LBT, for example, a random backoff-based clear channel assessment and a non-random backoff-based clear channel assessment. Specifically, Cat.2 LBT and Cat.4 LBT may be used as examples for description.

Cat.2 LBT is a non-random backoff-based clear channel assessment (CCA). For example, a channel may be sensed at a sending node, and if it is detected that the channel is idle within 25 us, the sending node may immediately occupy the channel to send data.

Cat.4 LBT is a random backoff-based CCA, and a required sense duration needs to be randomized. Cat.4 LBT may specifically be: A sending node evenly and randomly generates a backoff counter N between 0 and a contention window length (CWS), and performs sense by using a sense slot (CCA slot) as the granularity. If it is detected in the sense slot that a channel is idle, the backoff counter is reduced by 1. Otherwise, if it is detected that the channel is busy, the backoff counter is suspended, that is, the backoff counter N remains unchanged within a time period during which the channel is busy, until it is detected that the channel is idle. When the backoff counter is reduced to 0, the sending node may immediately occupy the channel.

Before the backoff counter, the base station at least needs to detect that the channel is idle within a defer duration. A formula for calculating the duration of the defer duration is (16+9*mp), and a value of mp may be shown in the following Table 1 based on a value of a priority class. Before sending the data, the base station initializes, based on the used priority class, a period of time for which an idle channel is needed. Usually, a higher priority class indicates a shorter period of time for which an idle channel is needed, but also a shorter period of time for which data can be sent.

TABLE 1

| Channel | | | | | | |
|---|---|---|---|---|---|---|
| access | | | | | | |
| priority | | | | | | |
| class | | | | | | |
| (Channel | | | | | | |
| Access | | | | | | |
| Priority | | | | | | Allowed CWₚ |
| Class) (p) | mₚ | CW_{min,p} | CW_{max,p} | T_{mcot,p} | | sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

CW_{min, p} indicates a minimum value of the contention window length, CW_{max, p} indicates a maximum value of the contention window length, and CWₚ indicates an allowed value of the contention window length. T_{mcot, p} indicates a maximum period of time for which data is allowed to be sent. For example, using a priority class 1 as an example, a random number, for example, 0, is selected from 0 to 7, meaning that a period of time for which the base station needs to perform sense is 25+25*0=25 us. If the random number is 7, meaning that the period of time for which the base station needs to perform sense is 25+9*7=88 us. Therefore, for Cat.4 LBT, a minimum period of time for which the base station needs to perform sense is 25 us.

There are two channel states: a channel is idle and the channel is busy. A criterion for determining a channel state is: A wireless communications device compares power on the channel received within the sense slot with an energy detection threshold. If the power is greater than the threshold, the channel state is busy; or if the power is less than the threshold, the channel state is idle.

A discovery signal measurement timing configuration (DMTC) is used to indicate an opportunity for sending a discovery signal based on a configuration parameter, where the configuration parameter thereof may include a period (dmtc-Periodicity-mf) of the DMTC, a start location (dmtc-Offset-mf) of a subframe of a DMTC window within the period, and a length (dmtc-WindowSize-mf) of the DMTC window.

A DRS is used by UE to implement a network access process by receiving a DRS of a base station device.

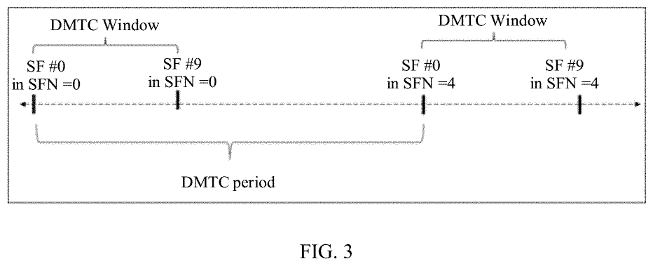

For a DRS sending opportunity, that is, a configuration parameter of the DMTC corresponding to the DRS, for example, if dmtc-Periodicity-mf is configured as 40 ms, dmtc-Offset-mf is configured as 0, and dmtc-WindowSize-mf is configured as 10 ms. It indicates that the start location of the subframes of the DMTC window is a subframe 0, namely, a subframe 0 of a radio frame, and each radio frame includes 10 subframes. The period of the DMTC is 40 ms, and the length of the DMTC window within the period is 10 ms, namely, the subframe 0 to a subframe 9, as shown in FIG. 3. In the DMTC window, the base station may perform, based on the configuration parameter of the DMTC, namely, the subframe 0 to the subframe 9, channel sense via Cat.2 LBT, at 25 us before the subframe 0 starts. If it is sensed that the channel is always in an idle state within 25 us, the base station sends the DRS. If Cat.2 LBT fails, that is, it is sensed that the channel is not always in an idle state within 25 us, the base station may continue to perform channel sense by Cat.2 LBT at 25 us before a next subframe 1 starts, and if Cat.2 LBT succeeds before a subframe, the base station sends the DRS in the subframe.

A network architecture and a service scenario that are described in the embodiments of this application are intended to describe technical solutions in the embodiments of this application more clearly, and do not constitute a limitation to the technical solutions provided in the embodiments of this application. A person of ordinary skill in the art may know that with evolution of the network architecture and emergence of a new service scenario, the technical solutions provided in the embodiments of this application are also applicable to the similar technical problems.

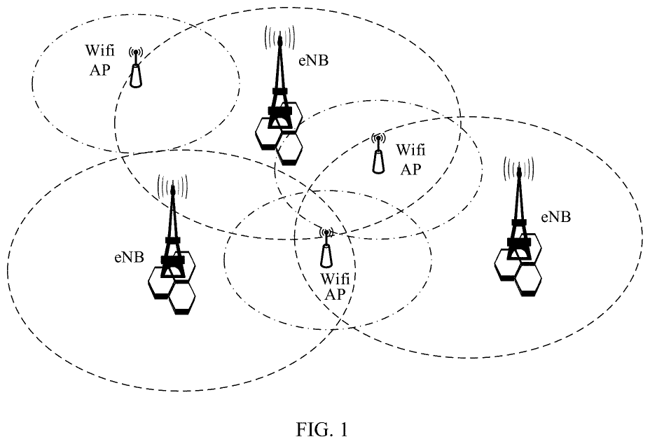

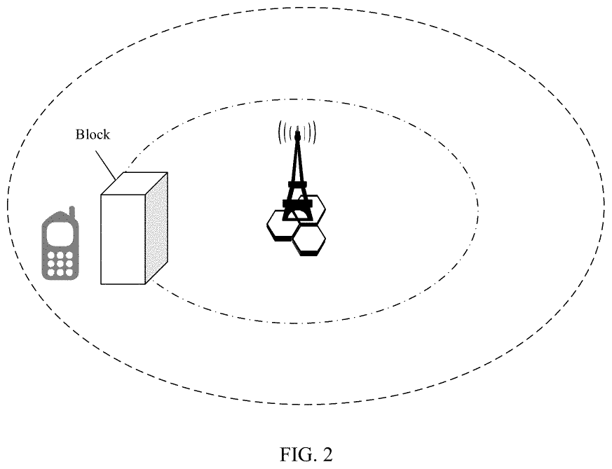

The embodiments of this application may be applied to enhancement of a discovery signal on an unlicensed band in a long term evolution (LTE) broadband system or a MulteFire (MF) system. One of features of the unlicensed band is to allow different units and individuals and systems of different standards to use a same frequency band. At present, the unlicensed band is mainly used by a wifi system. One of scenarios in which an MF base station deployed based on the unlicensed band coexists with wifi may be shown in FIG. 1. The MF system can be independently deployed on the unlicensed band, and can be adapted to an intelligent operation such as an enterprise, a factory, a workshop, and a warehouse. However, these independent deployment scenarios have some requirements for deep coverage, for example, control over an automated guided vehicle (AGV) in a harbor. When a container blocks or a pillar blocks between vehicles, signal fading is severe, and in this case, coverage needs to be enhanced, as shown in FIG. 2.

The network architecture in the embodiments of this application may include a base station device and user equipment.

The base station (BS) device may also be referred to as a base station, and is an apparatus deployed in a radio access network to provide a wireless communication function. For example, in a 2G network, a device providing a base station function includes a base transceiver station (BTS) and a base station controller (BSC); in a 3G network, a device providing a base station function includes a NodeB and a radio network controller (RNC); in a 4G network, a device providing a base station function includes an evolved NodeB (eNB); and in a wireless local area network (WLAN), a device providing a base station function is an access point (AP). In a 5G communications system, a device providing a base station function includes a new radio NodeB (gNB), a centralized unit (CU), a distributed unit, a new radio controller, and the like.

The user equipment (UE) is a terminal device, and may be a mobile terminal device or an immobile terminal device. The terminal device is mainly configured to receive or send service data. The user equipment may be distributed in a network. The user equipment has different names in different networks, for example, a terminal, a mobile station, a subscriber unit, a station, a cellular phone, a personal digital assistant, a wireless modem, a wireless communications device, a handheld device, a laptop computer, a cordless phone, and a wireless local loop station. The user equipment may communicate with one or more core networks by using a radio access network (RAN) (an access part of a wireless communications network), for example, exchanging voice and/or data with the radio access network.

When multi-user scheduling exists in downlink, power is shared among a plurality of users, a downlink user cannot send data at full power, so that coverage enhancement design needs to be performed on a downlink channel in this scenario.

In embodiments of this application, another discovery signal, namely, an enhanced discovery signal (eDRS), may be defined. A core difference between the eDRS and the DRS is that a quantity of subframes occupied when the eDRS is sent is different from a quantity of subframes occupied when the DRS is sent. The DRS occupies one subframe, while the eDRS may occupy a plurality of subframes, so that a probability that the downlink user receives the discovery signal is increased, thereby improving cell coverage performance. The base station in this embodiment of this application can send the eDRS, ensuring cell coverage performance.

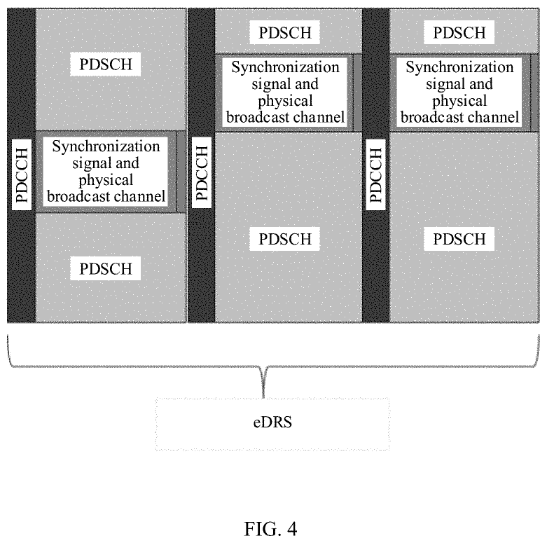

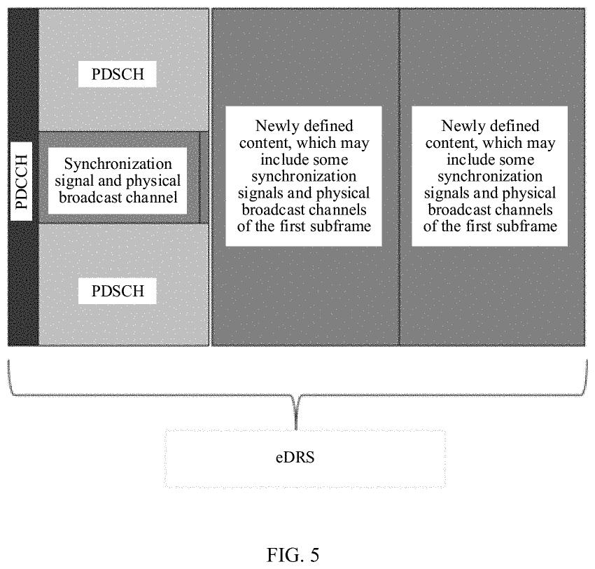

Different from the DRS, for the eDRS, the eDRS occupies a plurality of subframes in time domain. Two possible formats of the eDRS are described herein. A first possible format is: The eDRS occupies a plurality of subframes, of which the first subframe includes or is compatible with a conventional DRS, and subframes other than the first subframe also include DRSs. However, synchronization signals and broadcast channels of the DRSs included in the first subframe and other subframes are different (or may be partially the same), and time domain resource locations, signal formats, and channel formats are all the same. As an example, when the eDRS occupies three subframes, the format of the eDRS may be the format shown in FIG. 4. A second possible format is: The eDRS occupies a plurality of subframes, of which only the first subframe includes or is compatible with a conventional DRS, while the other subframes are newly defined DRSs, and do not include the conventional DRS, but may include a part of content of the conventional DRS, for example, include a part of a synchronization signal and a broadcast channel. As an example, when the eDRS occupies three subframes, the format of the eDRS may be the format shown in FIG. 5.

In the first possible format, the eDRS occupies the plurality of subframes in time domain, and five subframes are used as an example. The first subframe of the eDRS includes the DRS, is used to be compatible with a conventional terminal device, and is denoted as a 1.0 DRS. 1.0 is an MF standard version number. A case of subsequent four subframes may be, for example: the second subframe to the fourth subframe are newly defined DRSs of the eDRS and are denoted as 1.1 DRSs, and the fifth subframe is a 1.0 DRS; or the second subframe, the third subframe, and the fifth subframe are 1.1 DRSs, and the fourth subframe is a 1.0 DRS.

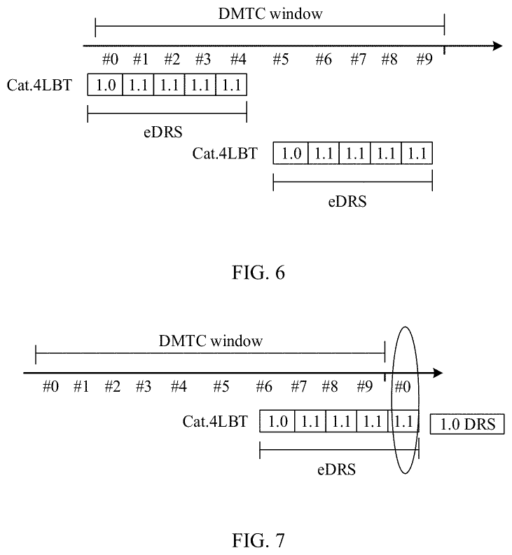

In the second possible format, the eDRS occupies the plurality of subframes in time domain, and five subframes are used as an example, as shown in FIG. 6. The first subframe of the eDRS includes the DRS, namely, a 1.0 DRS, and four subsequent subframes are newly defined DRSs, which are denoted as 1.1 DRSs, and are used by an MF 1.1 terminal to receive the eDRS. Because the eDRS occupies the plurality of subframes, the base station can no longer perform Cat.2 LBT for channel sense when the DRS is sent, and may perform first carrier sense. The first carrier sense may be Cat.4 LBT. A period of time for which an idle channel is needed to successfully perform Cat.4 LBT is not shorter than a period of time for which an idle channel is needed to successfully perform Cat.2 LBT. For example, in an existing DMTC configuration, the base station performs Cat.4 LBT before the first subframe 0, namely, a start location, in the DMTC window. If Cat.4 LBT succeeds, the eDRS starts to be sent from the subframe 0 to a subframe 4. If Cat.4 LBT fails, Cat.4 LBT continues to be performed before a next subframe until Cat.4 LBT succeeds, to send the eDRS. If Cat.4 LBT performed by the base station fails on the subframe 0 to a subframe 5, Cat.4 LBT can continue to start to be performed only before a subframe 6. If Cat.4 LBT succeeds before the subframe 6, the eDRS is delivered in the subframe 6. In this case, a last subframe occupied by the eDRS exceeds the DMTC window, and it is a 1.1 DRS, as shown in FIG. 7. However, it is specified in an existing standard (MulteFire Release 1.0) that if any subframe 0 outside of the DMTC window is a downlink subframe, the eNB needs to send the conventional DRS, namely, a 1.0 DRS. In this case, the eDRS needs to define a plurality of formats based on a location of the start subframe. The UE needs to know a specific format of the received eDRS for demodulation. Otherwise, the UE needs to try each possible format to blindly detect the eDRS, resulting in excessively high complexity.

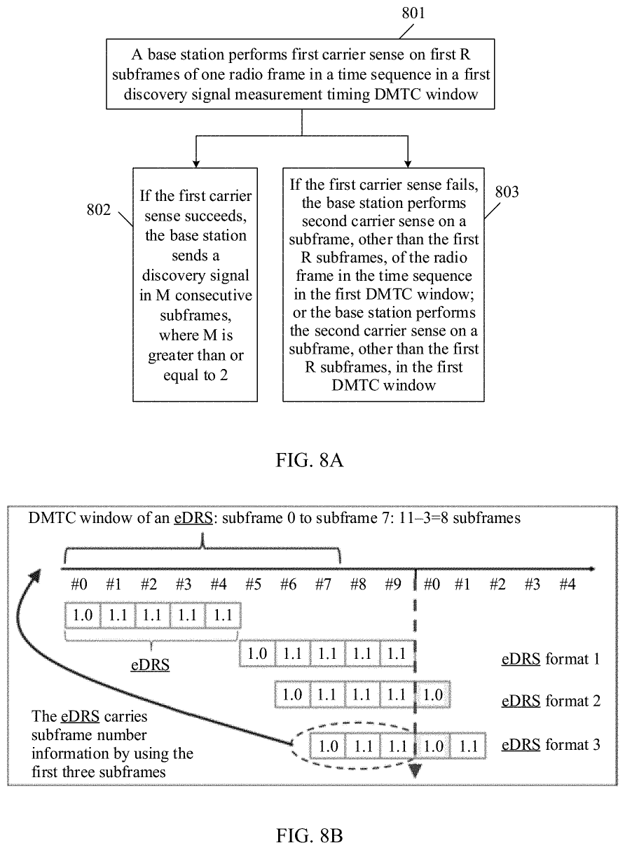

The embodiments of this application provide a method for sending a discovery signal and a method for detecting a discovery signal, to improve cell coverage performance. FIG. 8A illustrates a schematic flowchart of a DMTC configuration method according to an embodiment of this application

Step 801. A base station performs first carrier sense on first R subframes of one radio frame in a time sequence in a first discovery signal measurement timing (DMTC) window; and selects to perform step 802 or step 803 based on a result of the first carrier sense.

In an optional implementation, the first carrier sense is used to determine whether the discovery signal can be sent in a plurality of consecutive subframes. Specifically, the first carrier sense may be first-level carrier sense. Sending the discovery signal in the plurality of consecutive subframes may be repeatedly sending a DRS in a plurality of subframes, or may be occupying the plurality of subframes to send an eDRS. For a structure of the eDRS, refer to the two formats in the foregoing description.

In another optional implementation, a configuration parameter of the first DMTC window further includes a length N of the DMTC window (that is, a quantity of subframes included in one DMTC window), a period of the DMTC window, and a subframe start location of the DMTC window in the period.

The first DMTC window may include one or more radio frames, or a part of one radio frame.

For example, the length N of the first DMTC window may be one radio frame 10 ms, the period of the DMTC window may be 40 ms, and the subframe start location may be a subframe 0.

In another optional implementation, the performing, by a base station, first carrier sense on first R subframes of one radio frame in a time sequence in a first discovery signal measurement timing (DMTC) window specifically includes:
first performing, by the base station, the first carrier sense on a first subframe of the radio frame in the first DMTC window; if the first carrier sense fails, continuing, by the base station, to perform the first carrier sense on a next subframe in the time sequence, or if the sense succeeds, performing, by the base station, step 802; otherwise, continuing, by the base station, to perform the first carrier sense on a next but one subframe in the time sequence. Performing carrier sense on the first subframe may be understood as performing the first carrier sense before the first subframe, to determine whether a channel is idle.

Based on the above described procedure, the first DMTC window configured in the embodiment of this application may support sending of the eDRS in one DMTC window, and the first R subframes of the radio frame in the time sequence in the first DMTC window may be used as the subframe start location of the eDRS. Optionally, a subframe, other than the first R subframes, of one radio frame in the time sequence in the first DMTC window may be used as the subframe start location of the DRS, or a subframe, other than the first R subframes, in the first DMTC window may be used as the subframe start location of the DRS. In this way, an eNB can obtain an eDRS sending opportunity and a DRS sending opportunity in the radio frame in the first DMTC window.

Step 802. If the first carrier sense succeeds, the base station sends a discovery signal in M consecutive subframes, where M is greater than or equal to 2.

That the first carrier sense succeeds indicates that the base station determines that a first channel is idle and may be used to send the discovery signal. For example, it may be understood that the base station successfully performs the first carrier sense before the first subframe and determines that the channel is idle. For example, the first DMTC window includes 10 subframes. If the first carrier sense performed by the based station succeeds on the second subframe, namely, a subframe 1, within a range of first six subframes, the base station determines that the channel is idle in this case, and may be used to send the discovery signal.

The M consecutive subframes may be subframes in which a plurality of DRSs are repeatedly sent, or may be subframes occupying the M consecutive subframes for sending the eDRS.

In an optional implementation, when the first carrier sense performed by the base station succeeds on a subframe of the first R subframes of the radio frame in the time sequence in the first discovery signal measurement timing (DMTC) window, the base station sends the discovery signal in the M consecutive subframes starting from the subframe. In this implementation, the discovery signal can be carried in a plurality of subframes, so that enhanced discovery signal transmission is supported, to implement accessing UE in a weak coverage scenario, thereby ensuring the cell coverage performance.

In another optional implementation, a value of M may be a preset value, for example, specified in a standard or a protocol, or may be dynamically or semi-statically configured by the base station. The base station may dynamically configure or semi-statically configure, periodically or in another manner, a quantity M of subframes occupied by the discovery signal.

Further, optionally, the discovery signal carried in the M consecutive subframes may specifically be: a plurality of DRSs repeatedly sent in the M consecutive subframes or an eDRS sent in the M consecutive subframes.

Further, optionally, the first subframe of the M consecutive subframes is compatible with or includes a conventional discovery signal.

Further, optionally, the value of M is 5.

Specifically, when the first carrier sense is Cat.4 LBT, if the base station successfully performs Cat.4 LBT, the base station determines that the first carrier sense succeeds on an L^{th} subframe in the first DMTC window. The L^{th} subframe is located in the first R subframes of the radio frame in the time sequence in the first DMTC window, and the base station starts to send, in the L^{th} subframe, the discovery signal occupying the M consecutive subframes.

In still another optional implementation, if the first carrier sense on a subframe in the first R subframes succeeds, the base station determines that a quantity of subframes located after the subframe in the time sequence in the first discovery signal measurement timing (DMTC) window is greater than or equal to M. M is a quantity of subframes occupied by the enhanced discovery signal (eDRS), and M is greater than 1. Therefore, the base station sends the eDRS.

In a possible implementation, a maximum quantity of subframes of a DMTC window in the existing standard (MulteFire Release 1.0) is 10, and the subframes include a subframe 0 to a subframe 9 and constitute one radio frame. The quantity M of subframes occupied by the eDRS configured in the embodiments of this application may be two or more, and may be a fixed format. For example, the first subframe is a 1.0 DRS, and remaining subframes are 1.1 DRSs. The first DMTC window configured in this embodiment of this application may include N subframes. Therefore, if N is less than or equal to 11-M, R is less than or equal to N; if N is greater than 11-M, R is less than or equal to 11-M. To be specific, a subframe location at which the first carrier sense may be performed in the first DMTC window to send the eDRS is determined based on the length N of the first DMTC window and the quantity M of subframes occupied by the eDRS. In the above described two cases, a maximum value of R is 11-M, ensuring that even if the subframes occupied by the eDRS belong to a plurality of radio frames, the subframes do not occupy the subframe 0 outside an existing DMTC window, and ensuring that a subframe format of the eDRS does not conflict with the standard specified for the conventional systems that the subframe 0 outside of the window needs to be a 1.0 DRS.

When N is less than or equal to 11-M, and R is less than or equal to N, any subframe in all subframes in the first DMTC window may be used to perform the first carrier sense, to be used as a start subframe in which the eDRS is sent when the first carrier sense succeeds.

For example, a minimum value of the quantity M of subframes occupied by the eDRS is 2, and N is equal to 9. In other words, the first DMTC window includes a subframe 0 to a subframe 8, and in this case, R is equal to 9. In other words, if the first carrier sense performed by the base station succeeds on the subframe 8, the subframes occupied by the eDRS is the subframe 8 in the first DMTC window and a subframe 9 outside of the first DMTC window based on a subframe number sequence. It may be ensured that even if the subframes occupied by the eDRS in the embodiment of this application exceed the window, the subframes do not conflict with the requirement that the first subframe 0 outside of the window needs to be a 1.0 DRS, when the length of the existing DMTC window is 10.

For another example, the quantity M of subframes occupied by the eDRS is 5, N is less than or equal to 6, and R is less than or equal to 6. When the length of the first DMTC window is 6, and a subframe 0 to a subframe 5 are included, even if the first carrier sense succeeds only on the sixth subframe, namely, the subframe 5, and in this case, the subframes occupied by the eDRS include the subframe 5 in the first DMTC window and a subframe 6 to a subframe 9 outside of the first DMTC window. That is, the subframes do not conflict with the requirement that the first subframe 0 outside of the window needs to be a 1.0 DRS, when the length of the existing DMTC window is 10.

In another embodiment of this application, N is greater than 11-M, R is less than or equal to 11-M, and M is still 2. In this embodiment, when N is equal to 10, a maximum value of R is 9. To be specific, if the first carrier sense succeeds on the subframe 8, the subframes occupied by the eDRS are the subframe 8 and the subframe 9 in the first DMTC window based on the subframe number sequence. It may be ensured that no subframe occupied by the eDRS in this embodiment of this application exceeds the first DMTC window or conflicts with the requirement that the first subframe 0 outside of the window needs to be a 1.0 DRS, when the length of the existing DMTC window is 10.

For another example, the eDRS occupies five subframes, and the length N of the first DMTC window is 10. In this case, R is 6. To be specific, the first DMTC window includes the subframe 0 to the subframe 9, and a start subframe of the five subframes occupied by the eDRS may be any subframe of the subframe 0 to the subframe 5. For example, the first carrier sense succeeds on the subframe 5, the five subframes occupied by the eDRS include the subframe 5 to the subframe 9, and the subframes occupied by the eDRS do not exceed the first DMTC window.

The embodiments of this application further provides a method for determining, based on the length N of the first DMTC window and a quantity Q of subframes carrying subframe numbers when the eDRS is sent, locations of first R subframes of one radio frame that can be used to perform the first carrier sense, where the first R subframes can be used as a range of a start subframe of subframes occupied by the eDRS. Q is less than or equal to a quantity M of subframes occupied by the eDRS.

In a possible implementation, if N is less than or equal to 11-Q, R is less than or equal to N; or if N is greater than 11-Q, R is less than or equal to 11-Q. In this case, because a value of Q is less than M, and 11-Q is larger than 11-M, when R is less than or equal to 11-Q, the subframes occupied by the eDRS may belong to a plurality of radio frames, in other words, a subframe 0 outside an existing DMTC window may be occupied.

Therefore, in the embodiments of this application, a sending format of the eDRS may be determined based on the quantity M of subframes occupied by the eDRS and the value of Q of first Q subframes carrying the subframe numbers. In this way, even if the subframes occupied by the eDRS include the subframe 0 outside of the existing DMTC window, UE can also demodulate the subframe numbers of the first Q subframes based on the first Q subframes, thereby determining the sending format of the eDRS and avoiding the above described conflict.

In a possible implementation, assuming that M subframes are occupied when the eDRS is sent, and the first Q subframes carry the subframe numbers, 1) if a subframe number of a start subframe occupied when the eDRS is sent is greater than or equal to 0 and is less than or equal to 10-M, subframe formats of last M-Q subframes occupied by the eDRS may not be 1.0 DRSs, in other words, the subframe formats of the last M-Q subframes may all be 1.1 DRSs because the subframes occupied by the eDRS do not include the subframe 0 outside of the existing DMTC window, in other words, do not conflict with an existing standard that the subframe 0 outside of the DMTC window is a 1.0 DRS; 2) if the subframe number of the start subframe occupied when the eDRS is sent is greater than 10-M and is less than or equal to 10-Q, a format of the subframe 0 in the last M-Q subframes occupied by the eDRS may be a 1.0 DRS because if the subframe number of the start subframe occupied by the eDRS is greater than 10-M and is less than or equal to 10-Q, the last M-Q subframes occupied by the eDRS include the subframe 0 outside of the existing DMTC window. To avoid a conflict, the format of the subframe 0 in the last M-Q subframes occupied by the eDRS may be set to a 1.0 DRS.

When N is less than or equal to 11-Q, and R is less than or equal to N, any subframe in the first DMTC window may be used to perform the first carrier sense; and at most N subframes may be used to perform the first carrier sense, and a subframe on which the first carrier sense succeeds is used as the start subframe in which the eDRS starts to be sent. For example, Q=3, that is, first three subframes of the eDRS carry subframe numbers, N is 8, and R is also 8. In this case, subframes in the first DMTC window include a subframe 0 to a subframe 7, and a maximum subframe number of the start subframe occupied by the eDRS may be 7, in other words, all subframes in the first DMTC window can be used to perform the first carrier sense.

When N is greater than 11-Q, and R is less than or equal to 11-Q, in other words, if the length N of the first DMTC window is greater than 11-Q, the base station may perform the first carrier sense in total 11-Q subframes from a subframe 0 to a subframe 10-Q of one radio frame in the first DMTC window. For example, when Q is 3 and N is 10, subframes in which the base station may perform the first carrier sense are the subframe 0 to a subframe 7 in the first DMTC window.

It can be learned that, according to a case in which the length of the DMTC window is less than or equal to 10 and that is specified in the existing standard, regardless of a value of the length N of the first DMTC window, the base station may perform the first carrier sense in at most 11-Q subframes in the first DMTC window.

For example, assuming that a value of Q is 3, the quantity M of subframes occupied by the eDRS is 5, and the length N of the first DMTC window is 10, the base station may perform the first carrier sense on at most eight subframes in the first DMTC window, and the subframes include a subframe 0 to a subframe 7.

When N is less than or equal to 8, for example, N is 6, if the first carrier sense succeeds on a subframe whose subframe number is greater than or equal to 0 and is less than or equal to 5, a maximum range of the subframe numbers of the subframes occupied by the eDRS is a subframe 5 to a subframe 9, and the subframes include the subframe 5 to a subframe 7 in the first DMTC window and a subframe 8 and the subframe 9 outside of the first DMTC window.

According to the above described two formats of the eDRS, when the subframes occupied by the eDRS are the subframe 5 to the subframe 9, the subframe 0 outside of the existing DMTC window is not occupied, and subframe formats of last M-Q subframes occupied by the eDRS, namely, last two subframes, may not be 1.0 DRSs. In other words, the subframe formats of the last two subframes may both be 1.1 DRSs, and are different from formats of 1.0 DRSs. In this case, the format of the eDRS may be an eDRS format 1 shown in FIG. 8B, in other words, the first subframe of the eDRS is a 1.0 DRS, and is used to be compatible with an existing standard format; and formats of the other four subframes may all be 1.1 DRSs.

If the first carrier sense succeeds on a subframe whose subframe number is greater than 5 and less than or equal to 7, in other words, the subframe number of the start subframe occupied when the eDRS starts to be sent may be 6 or 7, regardless of whether the length N of the first DMTC window is less than or equal to 8 or is greater than 8, the fifth subframe or the fourth subframe of the five subframes occupied by the eDRS occupies the subframe 0 outside of the existing DMTC window. To avoid the above described conflict, a format of the subframe 0 in the last two subframes occupied by the eDRS may be set to a 1.0 DRS. As shown in FIG. 8B, for example, if the subframe number of the start subframe occupied when the eDRS is sent is 6, a format of a subframe 6 may be set to a 1.0 DRS, formats of a subframe 7 to a subframe 9 may be set to 1.1 DRSs, and a format of the subframe 0 outside of the existing DMTC window may be set to a 1.0 DRS, for example, an eDRS format 2 in FIG. 8B. If the subframe number of the start subframe occupied when the eDRS is sent is 7, the format of the subframe 7 may be set to a 1.0 DRS, the formats of the subframe 8 and the subframe 9 may be set to 1.1 DRSs, the format of the subframe 0 outside of the DMTC window may be set to a 1.0 DRS, and a subframe 1 outside of the DMTC window may be set to a 1.1 DRS, for example, an eDRS format 3 in FIG. 8B.

For the UE, the UE learns of the quantity M of subframes occupied by the eDRS in advance. When the first Q subframes, in which the eDRS is sent, carry subframe numbers, the UE can deduce the subframe numbers occupied by the last M-Q subframes, thereby determining the subframe format of the eDRS.

Step 803. If the first carrier sense fails, the base station performs second carrier sense on a subframe, other than the first R subframes, of one radio frame in the time sequence in the first DMTC window; or optionally, the base station performs second carrier sense on a subframe, other than the first R subframes, in the first DMTC window.

For example, the length of the first DMTC window is N, and the base station performs the second carrier sense on the subframe, other than the first R subframes, of one radio frame in the time sequence in the first DMTC window. In other words, if the second carrier sense performed on the subframe, other than the first R subframes, in the time sequence in the first DMTC window succeeds, the base station sends a discovery signal in one subframe in the first DMTC window. The discovery signal occupies only one subframe, and may be a conventional discovery signal or any newly defined discovery signal. This is not limited in embodiments of this application.

If the second carrier sense performed on the subframe, other than the first R subframes, in the time sequence in the first DMTC window fails, the base station cannot obtain a sending opportunity in the first DMTC window, and will not send the discovery signal.

That the second carrier sense succeeds indicates that the base station determines that a first channel is idle, and may be used to send the discovery signal.

If the first DMTC window includes a plurality of radio frames, and if the first carrier sense fails, the base station may perform the second carrier sense on the subframe, other than the first R subframes, of one radio frame in the first DMTC window.

In an optional implementation, the second carrier sense is used to determine whether the discovery signal can be sent in one subframe. Specifically, the second carrier sense may be second-level carrier sense, for example, the above described Cat.2 LBT, which is used to determine whether the DRS can be sent in one subframe.

In another optional implementation, the performing, by the base station, second carrier sense on a subframe, other than the first R subframes, of one radio frame in the time sequence in the first DMTC window specifically includes:
first performing, by the base station, the second carrier sense on the first subframe of the subframe, other than the first R subframes, of the radio frame in the time sequence in the first DMTC window; if the second carrier sense fails, continuing, by the base station, to perform the second carrier sense on a subframe next to the subframe, other than the first R subframes, in the time sequence, or if the sense succeeds, sending a discovery signal in the subframe on which the sense succeeds; otherwise, continuing, by the base station, to perform the second carrier sense on a next but one subframe in the time sequence.

It should be noted herein that the first carrier sense and the second carrier sense in this embodiment of this application are not limited to the foregoing description. The first carrier sense and the second carrier sense may be different in one or more aspects of sense duration, a sense manner, occupation duration, and the like. The above described levels may also be distinguished based on different existing sense manners, for example, a backoff-based sense manner and a non-backoff-based sense manner. Specifically, Cat.4 LBT and Cat.2 LBT belong to different sense levels, and may be further defined based on a difference between one or more values of the sense duration, the sense manner, the occupation duration, and the like. This is not limited in embodiments of this application. For example, the first carrier sense may be a backoff-based CCA, for example, the above described Cat.4 LBT, so that when the first carrier sense succeeds, a discovery signal that occupies a plurality of consecutive subframes is sent. The second carrier sense may be a non-backoff-based CCA, for example, the above described Cat.2 LBT, and may be used to send a discovery signal that occupies only one subframe when the sense succeeds.

It should be further noted herein that performing carrier sense (the first or the second carrier sense) on a subframe mentioned in this embodiment of this application means that within a period of time before the subframe (in other words, within a period of time in a last subframe before the subframe in time), the base station performs the first carrier sense or the second carrier sense. When a corresponding carrier sense condition is met, the sense succeeds, and in this case, it is determined that the channel is idle, and the subframe may be used to send a signal.

It should be noted herein that any subframe in the first DMTC window may be used to carry a discovery signal that occupies only one subframe.

It may be understood that the eNB may determine, based on the length N of the first DMTC window and the quantity M of subframes occupied by the eDRS, that the eNB may attempt to perform Cat.4 LBT in the radio frame in the first DMTC window to send the first R subframes of the eDRS, or determine, based on the length N of the first DMTC window and the quantity Q of the subframes carrying the subframe numbers when the eDRS is sent, that the eNB may attempt to perform Cat.4 LBT in the radio frame in the first DMTC window to send the first R subframes of the eDRS. If the eNB determines that there is a relatively small quantity of UEs in a weak coverage scenario, Cat.4 LBT does not need to attempt to be performed a plurality of times in the first DMTC window to send the eDRS. In a possible implementation, if Cat.4 LBT always fails from the start location of the first DMTC window, the eNB may stop performing Cat.4 LBT on any subframe of the first R subframes in one radio frame in the first DMTC window, and attempt to perform Cat.2 LBT on remaining subframes in the radio frame in the first DMTC window. In another possible implementation, the eNB may alternatively start to always attempt to perform Cat.2 LBT from the first subframe of the first R subframes in the radio frame in the first DMTC window, and then send the DRS in a current subframe after Cat.2 LBT succeeds. If, in this case, the current subframe does not exceed the range of the first R subframes in the radio frame in the first DMTC window, the eNB may continue to attempt to perform Cat.4 LBT to start to send the eDRS in a subframe on which Cat.4 LBT succeeds. In still another optional implementation, user equipment (UE) detects a discovery signal in the first R subframes of the radio frame in the time sequence in the first DMTC window. The discovery signal is carried in the M consecutive subframes, and M is greater than or equal to 2.

Optionally, the UE considers that the first subframe of the M consecutive subframes is located in the radio frame in the first DMTC window. Therefore, the UE detects the discovery signal in the first R subframes in the radio frame. If the discovery signal is detected, the UE receives the discovery signal in the M consecutive subframes.

Further, optionally, when the first Q subframes of the M subframes occupied by the eDRS carry the subframe numbers, the UE may determine the subframe format of the eDRS based on the subframe numbers of the first Q subframes.

Further, optionally, if the UE does not detect the discovery signal in the first R subframes, the UE continues to detect a discovery signal in one subframe, other than the first R subframes, of the radio frame in the time sequence in the first DMTC window, and if the UE can detect the discovery signal, the discovery signal occupies only one subframe.

In still another optional implementation, R is less than or equal to N−M+1.

Optionally, a value of R is equal to N−M+1.

If the base station always performs the first carrier sense on the first R subframes until the first carrier sense on an R^{th} subframe succeeds, the base station sends a discovery signal in M subframes starting from the R^{th} subframe, thereby implementing sending of the discovery signal exactly in the first DMTC window.

Optionally, the value of R is less than N−M+1.

If the base station always performs the first carrier sense on the first R subframes until the first carrier sense on the R^{th} subframe succeeds, the base station sends the discovery signal in the M subframes starting from the R^{th} subframe. The subframes occupied by the discovery signal does not exceed the first DMTC window.

For example, in one DMTC window, the base station performs the first carrier sense on the first R subframes in the time sequence, and if the first carrier sense succeeds on the R^{th} subframe, the base station starts to send a discovery signal from the R^{th} subframe. The discovery signal is carried in the M consecutive subframes. The first carrier sense herein may be a backoff-based CCA, for example, Cat.4 LBT described in the foregoing description. In other words, in this embodiment of this application, the first DMTC window may be divided into two parts. The first part is the first R subframes in the time sequence, and the second part is a subframe, other than the first R subframes, in the time sequence, so that the base station performs the first carrier sense on the first part, so that the discovery signal that occupies the M consecutive subframes can be sent after the first carrier sense succeeds, thereby improving and ensuring cell coverage performance when the UE is in a weak coverage scenario. For the discovery signal, the start subframe of the discovery signal is in the first R subframes of the first part, so that sending of the M consecutive subframes does not exceed the first DMTC window.

For another example, the length of the DMTC window is N=10 ms, in other words, 10 subframes are included, and the period of the DMTC window may be 40 ms. If the discovery signal is sent in M=6 consecutive subframes, the base station performs the first carrier sense, for example, Cat.4 LBT, on the first five subframes in the DMTC window. In this case, even if the sense succeeds on the fifth subframe in the time sequence, sending of the discovery signal carried in six consecutive subframes does not exceed the length of the DMTC window. Optionally, if the first carrier sense fails on the first five subframes, the base station performs the second carrier sense, for example, Cat.2 LBT, on the last five subframes in the window because the last five subframes are insufficient to send the discovery signal sent in the six consecutive subframes. If the second carrier sense succeeds, the base station sends a reference signal that occupies one subframe. For another example, the period of the DMTC window may be 40 ms. When a next DMTC window is reached, the base station may further perform the above described carrier sense process on a subframe in the next window.

For still another example, the length N of the DMTC window is 10 ms, the quantity of subframes occupied by the eDRS is 5, and the eNB determines that there is a relatively small quantity of UEs in a weak coverage scenario. If the eNB fails to perform Cat.4 LBT before the subframe 0, and the eNB determines that an identifier 1 of a next subframe 1 is less than 5, the eNB continues to perform Cat.4 LBT before the next subframe 1. Similarly, if Cat.4 LBT still fails on a subframe 2 and a subframe 3, the eNB determines to perform Cat.2 LBT before a next subframe 4, and does not need to perform Cat.4 LBT anymore. It should be noted herein that the eNB may determine, based on an actual communication scenario and an actual communication status, when current-level carrier sense may be terminated, and another-level carrier sense may be used.

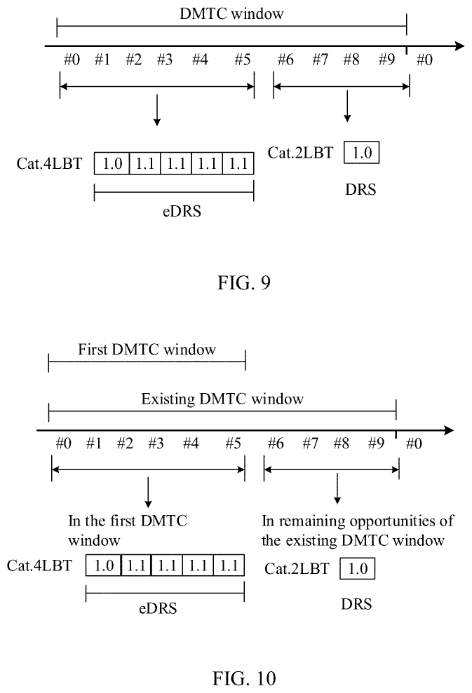

As shown in FIG. 9, for example, the length N of the DMTC window is 10 ms, and the quantity of subframes occupied by the eDRS is 5. If the eNB fails to perform Cat.4 LBT before the subframe 0, and the eNB determines that an identifier 1 of a next subframe 1 is less than 5, the eNB continues to perform Cat.4 LBT before the next subframe 1. Similarly, if Cat.4 LBT fails on the subframe 2, the subframe 3, and the subframe 4, and the eNB determines that the identifier 5 of a next subframe 5 is equal to a value 5 of N−M, the eNB still performs Cat.4 LBT before the subframe 5. If Cat.4 LBT succeeds before the subframe 5, the eNB may start to send the eDRS from the subframe 5, and the eDRS occupies the subframe 5 to a subframe 9 in this case. If Cat.4 LBT fails before the subframe 5, and the eNB determines that a value 6 corresponding to a next subframe R+1 is greater than the value 5 of N−M, the eNB performs Cat.2 LBT before the next subframe 6. If Cat.2 LBT succeeds before the subframe 6, the eNB sends the DRS in the subframe 6. If Cat.2 LBT fails before the subframe 6, the eNB continues to perform Cat.2 LBT before a subframe 7.

Enhanced discovery signal transmission is supported by using a new discovery signal measurement timing configuration, to implement accessing the UE in the weak coverage scenario, thereby ensuring the cell coverage performance. Assuming that the signal format of the eDRS is a standard format, for example, the first subframe of the above described eDRS is a 1.0 DRS, and remaining subframes are 1.1 DRSs, it can be ensured that subframes occupied for sending the eDRS are in one radio frame, and there is no subframe 0 outside of the DMTC window as specified in the existing standard, as in the existing standard, when the subframe 0 outside of the DMTC window is a downlink subframe, the subframe 0 needs to be a 1.0 DRS, conflicting with the eDRS. On the other hand, to avoid a conflict with the existing standard, a plurality of formats may be defined for the eDRS based on the quantity of subframes occupied by the eDRS and the quantity of subframes carrying the subframe numbers, so that the UE can determine, based on the subframe numbers, a format of the eDRS sent by the eNB, and the UE can detect the eDRS based on the determined format. In other words, if the first DMTC window configured in this embodiment of this application can enable the sending of the eDRS in one radio frame in the DMTC window, the signal format of the eDRS may be a standard format, and the UE may receive the eDRS based on the standard format of the eDRS. If the subframes occupied for sending the eDRS belong to a plurality of radio frames in the DMTC window, the subframe format of the eDRS may be set, to reduce complexity of implementing the eNB and the UE.

In another possible implementation, a start location of the first DMTC window configured in this embodiment of this application and a start location of an existing DMTC window may be the same, and the first DMTC window and the existing DMTC window both start from the subframe 0. The first DMTC window configured in this embodiment of this application is used to determine whether to perform the first carrier sense. In this embodiment of this application, a range of a quantity R of subframes in one radio frame that can be used to perform the first carrier sense may be determined based on the length N of the first DMTC window and the quantity M of subframes occupied by the eDRS that are configured in this embodiment of this application.

If the quantity of subframes occupied by the eDRS is M, the length of the first DMTC window configured in this embodiment of this application may be less than or equal to 11-M, or may be greater than 11-M, and a maximum value of R may be 11-M, so that subframes occupied when the eDRS is sent are in one radio frame. If first Q subframes of the subframes occupied by the eDRS carry subframe numbers, the maximum value of R may be 11-Q, so that even if the subframes occupied by the eDRS belong to a plurality of radio frames, the UE may also determine the sending format of the eDRS based on the subframe numbers carried by the first Q subframes.

In this way, a configuration parameter of the first DMTC window configured in this embodiment of this application may be configured as follows: A parameter dmtc-Periodicity-mf indicating the period of the first DMTC window may be, for example, 40 ms, 80 ms, or 160 ms; a parameter dmtc-Offset-mf indicating the start subframe of the first DMTC window may be selected based on the period; for example, when the parameter of the period is 160 ms, a location of the start subframe may be any location in a subframe 0 to a subframe 159; and a parameter dmtc-WindowSize-mf indicating the length of the first DMTC window within the period may be any value from 1 to 11-M, or if the first Q subframes in the M consecutive subframes carry the subframe numbers, the parameter dmtc-WindowSize-mf indicating the length of the first DMTC window may be any value from 1 to 11-Q.

In other words, the length of the first DMTC window may be greater than or equal to 1, and less than or equal to 11-M; or the length of the first DMTC window may be greater than or equal to 1, and less than or equal to 11-Q. Provided that Cat.4 LBT succeeds in the first DMTC window, the eDRS may start to be sent from a subframe on which Cat.4 LBT succeeds. Therefore, that the eNB performs the first carrier sense in step 801 may be understood as that the eNB performs the first carrier sense in the radio frame of the first DMTC window, or the eNB performs the first carrier sense before the first DMTC window, to determine whether the first subframe of the first DMTC window is available. That the eNB performs the first carrier sense in step 801 may be that the eNB performs Cat.4 LBT before a subframe in the radio frame in the first DMTC window. For example, Cat.4 LBT is performed before a subframe 0. If Cat.4 LBT succeeds before the subframe 0, the eNB starts to occupy the subframe 0 to a subframe 4 from the subframe 0 to send the eDRS. If Cat.4 LBT fails before the subframe 0 in the first DMTC window, the eNB continues to perform Cat.4 LBT before a next subframe. Once Cat.4 LBT fails before a subframe R, for example, Cat.4 LBT fails in a subframe 5 in the first DMTC window, the eNB attempts to perform Cat.2 LBT before a subframe 6, to be specific, a subframe 6 of the DMTC window configured in a conventional manner. If Cat.2 LBT succeeds before the subframe 6, the DRS is sent in the subframe 6. In other words, the length of the first DMTC window is 6, that is, from the subframe 0 to the subframe 5, and a start subframe is 0. As shown in FIG. 10, the eNB can perform Cat.4 LBT in the first DMTC window to attempt to send the eDRS. If Cat.4 LBT fails , Cat.2 LBT may be performed in remaining subframes of the existing DMTC window to attempt to send the DRS.

In still another optional implementation, the length of the first DMTC window may also exceed 11-Q, in other words, the value N of N subframes included in the first DMTC window may also be greater than 11-Q. However, an allowed opportunity of sending the eDRS is first 11-Q subframes of the radio frame in the time sequence in the first DMTC window, in other words, a start subframe in the M consecutive subframes is in the first 11-Q subframes in the radio frame. For example, the first DMTC window may be configured as follows: The parameter dmtc-Periodicity-mf indicating the period of the first DMTC window may be, for example, 40 ms, 80 ms, or 160 ms, and the parameter dmtc-Offset-mf indicating the start subframe of the first DMTC window may be selected based on the period. For example, when the parameter of the period is 160 ms, the location of the start subframe may be any location in the subframe 0 to the subframe 159, and the parameter dmtc-WindowSize-mf indicating the length of the first DMTC window within the period may be any value from 1 to 16. For example, the length of the first DMTC window is 16 ms, 10 subframes of one complete radio frame within the period and a part of one next radio frame, namely, first six subframes of the next radio frame in a time sequence, are included. If the quantity M of subframes occupied by the eDRS is 5, and first three subframes carry the subframe numbers, the base station can attempt to perform Cat.4 LBT only in first 11-3 subframes of one radio frame, namely, a subframe 0 to a subframe 7. If Cat.4 LBT succeeds on an R^{th} subframe from the subframe 0 to the subframe 7, the base station starts to send the eDRS in the corresponding R^{th} subframe.

In this way, the first DMTC window configured in the embodiment of this application may support sending of the first carrier sense, namely, Cat.4 LBT, in the first DMTC window. Optionally, if Cat.4 LBT fails in the first DMTC window, Cat.2 LBT attempts to be performed in remaining subframes, other than the first R subframes, of one radio frame in the time sequence in the first DMTC window, to facilitate sending of the DRS. In this way, in the configuration of the first DMTC window, the eNB may obtain an eDRS sending opportunity and a DRS sending opportunity, to ensure cell coverage performance. In addition, subframes occupied when the eDRS is sent do not exceed one radio frame. Based on the foregoing description, the signal format of the eDRS may be a standard format, so that the UE can receive the eDRS based on the standard format of the eDRS, or even if the subframes occupied when the eDRS is sent belong to a plurality of radio frames, the sending format of the eDRS may also be determined based on the subframe numbers of the first Q subframes occupied by the eDRS, so that the UE can receive the eDRS based on a corresponding format.

The foregoing mainly describes the solutions provided in this embodiment of this application from a perspective of the base station. It may be understood that, to implement the above described functions, the base station includes a corresponding hardware structure and/or software module for performing each of the functions. A person skilled in the art should be easily aware that, units and algorithm steps in the examples described with reference to the embodiments disclosed in this specification may be implemented by hardware or a combination of hardware and computer software. Whether a function is performed by hardware or hardware driven by computer software depends on particular applications and design constraints of the technical solutions. A person skilled in the art may use a different method for each particular application to implement the described functions, but it should not be considered that the implementation goes beyond the scope of this application.

In this embodiment of this application, division of function modules may be performed on the base station based on the above described method examples. For example, each function module may be obtained through division based on a corresponding function, or two or more functions may be integrated into one processing module. The above described integrated module may be implemented in a form of hardware, or may be implemented in a form of a software function module. It should be noted that, in this embodiment of this application, module division is an example, and is merely a logical function division. In actual implementation, another division manner may be used.

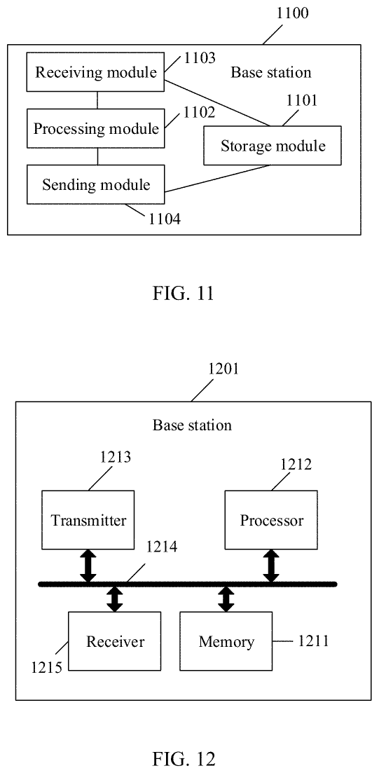

When an integrated unit is used, FIG. 11 is a possible schematic structural diagram of a base station 1100 in the above described embodiment. The base station 1100 includes: a storage module 1101, a processing module 1102, a receiving module 1103, and a sending module 1104. The processing module 1102 is configured to control and manage an action of the base station. The receiving module 1103 and the sending module 1104 are configured to support the base station in communicating with another network entity, for example, communicating with UE. The storage module 1101 is configured to store program code and data of the base station.

In this embodiment of this application, the receiving module 1103 is configured to perform first carrier sense on first R subframes of one radio frame in a time sequence in a first DMTC window. The processing module 1102 is configured to determine whether the first carrier sense succeeds. If the first carrier sense succeeds, the sending module 1104 is configured to send a discovery signal in M consecutive subframes, where M is greater than or equal to 2, and the first subframe of the M consecutive subframes is located in the radio frame in the first DMTC window; and both M and R are natural numbers.

In a possible implementation, the first DMTC window includes N subframes, where if N is less than or equal to 11-M, R is less than or equal to N; and if N is greater than 11-M, R is less than or equal to 11-M.

In a possible implementation, discovery signals carried in subframes of the M consecutive subframes may be the same or different.

In a possible implementation, the first DMTC window includes the N subframes, and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, before the base station sends the discovery signal, the base station determines a format of the discovery signal in the M consecutive subframes based on the subframe numbers of the first Q subframes.

In a possible implementation, if the first carrier sense fails, the receiving module 1103 is configured to perform second carrier sense on a subframe, other than the first R subframes, of one radio frame in the time sequence in the first DMTC window, or perform second carrier sense on a subframe, other than the first R subframes, in the first DMTC window.

In a possible implementation, if the second carrier sense succeeds, the sending module 1104 sends a discovery signal in one subframe in the first DMTC window.

In a possible implementation, the first DMTC window includes the N subframes; and if N is less than or equal to 11-Q, a start subframe in the M consecutive subframes is in the N subframes; or if N is greater than 11-Q, a start subframe in the M consecutive subframes is in first 11-Q subframes in the radio frame, where first Q subframes in the M consecutive subframes carry subframe numbers.

In a possible implementation, the first DMTC window includes one or more radio frames, or a part of one radio frame.

With reference to the above described method embodiments, for example, the receiving module 1103 is configured to support the base station in performing processes 801 and 803 in FIG. 8A, and/or used in another process of a technology described in this specification, the sending module 1104 is configured to support the base station in performing 802 in FIG. 8A, and/or used in another process of the technology described in this specification, and the processing module 1102 is configured to support the base station in determining that the first carrier sense succeeds or fails. The storage module 1101 is configured to store the program code and data that are used by the base station to perform the above described processes 801 to 803.

The processing module 1102 may be a processor or a controller, such as a central processing unit (CPU), a general-purpose processor, a digital signal processor (DSP), an application-specific integrated circuit (ASIC), a field programmable gate array (FPGA), or another programmable logical device, a transistor logical device, a hardware component, or a combination thereof. The processing module 1102 may implement or execute various example logical blocks, modules, and circuits described with reference to content disclosed in the embodiment of this application. Alternatively, the processor may be a combination implementing a computing function, for example, a combination of one or more microprocessors, or a combination of the DSP and a microprocessor. The receiving module 1103 may be a transceiver, a transceiver circuit, a communications interface, or the like. The storage module 1101 may be a memory.

When the processing module 1102 is a processor, the sending module 1104 is a transmitter, the receiving module 1103 is a receiver, and the storage module 1101 is a memory, the base station in this embodiment of this application may be a base station shown in FIG. 12.

Referring to FIG. 12, the base station 1201 includes: a processor 1212, a transmitter 1213, a memory 1211, a bus 1214, and a receiver 1215. The transmitter 1213, the processor 1212, the receiver 1215, and the memory 1211 are connected to each other by using the bus 1214. The bus 1214 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 12, but this does not mean that there is only one bus or only one type of bus.

In this embodiment of this application, the receiver 1215 may be configured to perform first carrier sense on first R subframes of one radio frame in a time sequence in a first discovery signal measurement timing (DMTC) window. If the first carrier sense succeeds, the transmitter 1213 is configured to send a discovery signal in M consecutive subframes, where M is greater than or equal to 2, and the first subframe of the M consecutive subframes is located in the radio frame in the first DMTC window.

Both M and R are natural numbers.

In a possible implementation, the first DMTC window includes N subframes; and if N is less than or equal to 11-M, R is less than or equal to N; or if N is greater than 11-M, R is less than or equal to 11-M.

In a possible implementation, discovery signals carried in subframes of the M consecutive subframes may be the same or different.

In a possible implementation, the first DMTC window includes N subframes; and first Q subframes in the M consecutive subframes carry subframe numbers, where Q is less than or equal to M; and if N is less than or equal to 11-Q, R is less than or equal to N; or if N is greater than 11-Q, R is less than or equal to 11-Q.

In a possible implementation, before the transmitter 1213 sends the discovery signal, the processor 1212 determines a format of the discovery signal in the M consecutive subframes based on the subframe numbers of the first Q subframes.

In a possible implementation, if the first carrier sense fails, the receiver 1215 is configured to perform second carrier sense on a subframe, other than the first R subframes, of one radio frame in the time sequence in the first DMTC window, or the receiver 1215 is configured to perform second carrier sense on a subframe, other than the first R subframes, in the first DMTC window.

In a possible implementation, if the second carrier sense succeeds, the transmitter 1213 is configured to send a discovery signal in one subframe in the first DMTC window.

In a possible implementation, the first DMTC window includes N subframes; and if N is less than or equal to 11-Q, a start subframe in the M consecutive subframes is in the N subframes; or if N is greater than 11-Q, a start subframe in the M consecutive subframes is in first 11-Q subframes in the radio frame, where the first Q subframes in the M consecutive subframes carry the subframe numbers.

In a possible implementation, the first DMTC window includes one or more radio frames, or a part of one radio frame.

With reference to the above described method embodiments, for example, the receiver 1215 is configured to support the base station in performing processes 801 and 803 in FIG. 8A, and/or used in another process of a technology described in this specification, the transmitter 1213 is configured to support the base station in performing 802 in FIG. 8A, and/or used in another process of the technology described in this specification, and the processor 1212 is configured to support the base station in determining that the first carrier sense succeeds or fails. The memory 1211 is configured to store program code and data that are used by the base station to perform the above described processes 801 to 803.

Method or algorithm steps described in combination with the content disclosed in the embodiment of this application may be implemented by hardware, or may be implemented by a processor by executing a software instruction. The software instruction may include a corresponding software module. The software module may be stored in a random access memory (RAM), a flash memory, a read-only memory (ROM), an erasable programmable read-only memory (EPROM), an electrically erasable programmable read-only memory (Electrically EPROM, EEPROM), a register, a hard disk, a mobile hard disk, a compact disc read-only memory (CD-ROM), or any other form of storage medium well-known in the art. For example, a storage medium is coupled to a processor, so that the processor can read information from the storage medium or write information into the storage medium. The storage medium may be a component of the processor. The processor and the storage medium may be located in the ASIC. In addition, the ASIC may be located in a core network interface device. The processor and the storage medium may exist in the core network interface device as separate components.

A person skilled in the art should be aware that in the above described one or more examples, functions described in the embodiments of this application may be implemented by hardware, software, firmware, or any combination thereof. When the functions are implemented by software, the above described functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

The objectives, technical solutions, and beneficial effects of this application are further described in detail in the above described specific embodiments. It should be understood that the foregoing descriptions are merely example embodiments of this application, but are not intended to limit the protection scope of this application. Any modification, equivalent replacement or improvement made based on technical solutions of this application shall fall within the protection scope of this application.

What is claimed is:

1. A communication method for sending one or more discovery signals, comprising:
performing, by a base station, first carrier sense on first R subframes of one radio frame in a time sequence in a first discovery signal measurement timing configuration (DMTC) window; and
if the first carrier sense succeeds, sending, by the base station, a discovery signal in M consecutive subframes, wherein M is greater than or equal to 2, and a first subframe of the M consecutive subframes is located in the radio frame in the first DMTC window, and both M and R are natural numbers.

2. The communication method according to claim 1, wherein
the first DMTC window comprises N subframes;
if N is less than or equal to 11-M, R is less than or equal to N; and
if N is greater than 11-M, R is less than or equal to 11-M.

3. The communication method according to claim 1, wherein
the discovery signal comprises multiple discovery signals carried in subframes of the M consecutive subframes, two or more of the multiple discovery signals being different.

4. The communication method according to claim 1, wherein
the first DMTC window comprises N subframes;
first Q subframes in the M consecutive subframes carry subframe numbers, Q being less than or equal to M;
if N is less than or equal to 11-Q, R is less than or equal to N; and
if N is greater than 11-Q, R is less than or equal to 11-Q.

5. The communication method according to claim 4, wherein the method further comprises:
before the sending, by the base station, a discovery signal, determining, by the base station, a format of the discovery signal in the M consecutive subframes based on the subframe numbers of the first Q subframes.

6. The communication method according to claim 1, wherein
if the first carrier sense fails, performing, by the base station, second carrier sense on a subframe, other than the first R subframes, of one radio frame in the time sequence in the first DMTC window, or performing, by the base station, second carrier sense on a subframe, other than the first R subframes, in the first DMTC window.

7. The communication method according to claim 6, wherein
if the second carrier sense succeeds, sending, by the base station, a discovery signal in one subframe in the first DMTC window.

8. The communication method according to claim 1, wherein
the first DMTC window comprises N subframes;
first Q subframes in the M consecutive subframes carry subframe numbers, Q being less than or equal to M;
if N is less than or equal to 11-Q, a start subframe in the M consecutive subframes is in the N subframes; and
if N is greater than 11-Q, the start subframe in the M consecutive subframes is in first 11-Q subframes in the radio frame.

9. The communication method according to claim 1, wherein
the first DMTC window comprises one or more radio frames, or a part of one radio frame.

10. A communication method for detecting one or more discovery signals, comprising:
detecting, by user equipment (UE), a discovery signal in first R subframes of one radio frame in a first discovery signal measurement timing configuration (DMTC) window, wherein
the discovery signal is carried in M consecutive subframes, and M is greater than or equal to 2,
the first subframe of the M consecutive subframes is located in the radio frame in the first DMTC window, and
both M and R are natural numbers.

11. The communication method according to claim 10, wherein
the first DMTC window comprises N subframes;
if N is less than or equal to 11-M, R is less than or equal to N; and
if N is greater than 11-M, R is less than or equal to 11-M.

12. The communication method according to claim 10, wherein
the first DMTC window comprises N subframes;
first Q subframes in the M consecutive subframes carry subframe numbers, Q being less than or equal to M,
if N is less than or equal to 11-Q, R is less than or equal to N, and
if N is greater than 11-Q, R is less than or equal to 11-Q.

13. The communication method according to claim 12, wherein the method further comprises:
determining, by the UE, formats of the M consecutive subframes based on the subframe numbers of the first Q subframes.

14. A base station, comprising a receiver and a transmitter, wherein
the receiver is configured to perform first carrier sense on first R subframes of a radio frame in a time sequence in a first discovery signal measurement timing (DMTC) window; and
if the first carrier sense succeeds, the transmitter is configured to send a discovery signal in M consecutive subframes, wherein M is greater than or equal to 2, and the first subframe of the M consecutive subframes is located in the radio frame in the first DMTC window; and
both M and R are natural numbers.

15. The base station according to claim 14, wherein
the first DMTC window comprises N subframes;
if N is less than or equal to 11-M, R is less than or equal to N; and
if N is greater than 11-M, R is less than or equal to 11-M.

16. The base station according to claim 14, wherein
the discovery signal comprises multiple discovery signals carried in subframes of the M consecutive subframes, two or more of the multiple discovery signals being different.

17. The base station according to claim 14, wherein
the first DMTC window comprises N subframes;
first Q subframes in the M consecutive subframes carry subframe numbers, Q being less than or equal to M,
if N is less than or equal to 11-Q, R is less than or equal to N, and
if N is greater than 11-Q, R is less than or equal to 11-Q.

18. The base station according to claim 17, further comprising a processor, wherein
before the transmitter is configured to send the discovery signal, the processor is configured to determine a format of the discovery signal in the M consecutive subframes based on the subframe numbers carried by the first Q subframes.

19. The base station according to claim 14, wherein
if the first carrier sense fails, the receiver is configured to perform second carrier sense on a subframe, other than the first R subframes, of one radio frame in the time sequence in the first DMTC window, or perform second carrier sense on a subframe, other than the first R subframes, in the first DMTC window.

20. The base station according to claim 19, wherein
if the second carrier sense succeeds, the transmitter is configured to send a discovery signal in one subframe in the first DMTC window.
